(19) United States
(12) Patent Application Publication
(10) Pub. No.: US 2008/0029248 A1
(43) Pub. Date: Feb. 7, 2008

(54) Laboratory Temperature Control With Ultra-Smooth Heat Transfer Surfaces

(75) Inventor: Gary P. Magnant, Topsfield, MA (US)

Correspondence Address: BROMBERG & SUNSTEIN LLP, 125 SUMMER STREET, BOSTON, MA, 02110-1618, US

(73) Assignee: SAGE SCIENCE, INC.

(21) Appl. No.: 11/685,549

(22) Filed: Mar. 13, 2007

Related U.S. Application Data
(60) Provisional application No. 60/781,892, filed on Mar. 13, 2006.
(60) Provisional application No. 60/786,047, filed on Mar. 27, 2006.
(60) Provisional application No. 60/796,493, filed on May 1, 2006.

(51) Int. Cl. G01N 27/447; F25B 21/02; F25D 17/00

(52) U.S. Cl. 165/104.19; 165/61; 204/621; 62/3.2; 62/467; 62/498

(57) ABSTRACT

A temperature regulation system has a polished surface sufficiently smooth so as to reduce the emissivity of the surface. A conduit is in thermal proximity to the polished surface and is in communication with a source of coolant. The coolant is circulated through the conduit so as to transfer heat from the surface to the coolant. System may include a sprayed-on resistive heater. An a temperature controlled vessel has a heat transfer wall that is of an electrically conductive material that is coated with a durable thermally conductive and electrically nonconductive coating. The coating may be a sprayed on coating and the vessel may hold a buffer for performing electrophoresis.

### CROSS REFERENCE TO RELATED APPLICATIONS

This application claims priority from the following U.S. Provisional Patent Applications:

Ser. No. 60/781,892 for “Electrophoresis Buffer Cooling” filed Mar. 13, 2006 (Attorney Docket No. 3094/103);

Ser. No. 60/786,047 for “Remote Bench Top Compressed Air Refrigeration System for Laboratory Use” received by the U.S.P.T.O. on Mar. 27, 2006 (filed pro se); and

Ser. No. 60/796,493 for “Electrophoresis Buffer Cooling” filed May 1, 2006 (Attorney Docket No. 3094/106).

### TECHNICAL FIELD

The present invention relates to devices that add or remove heat from a device or other object, including devices that use treated surfaces and/or miniature compressors.

### BACKGROUND

A variety of heating, cooling and thermocycling devices are routinely used by experimentalists to control the temperature of a particular reagent or reaction mixture. Some such temperature control devices have flat surfaces for heating beakers and the like, while others have surfaces adapted to transfer heat to or from eccentrically shaped objects, e.g., microtubes or round-bottom flasks. In illustrative uses, a heater may be used to boil a liquid in an Erlenmeyer flask, to denature nucleic acid solutions, or maintain a given temperature for stringent nucleic acid hybridization. A cooler may be used, for example, to maintain the stability of a given reactant by holding it near 4° C. prior to use.

Examples of heating and cooling mechanisms that have been incorporated into laboratory temperature control devices include resistive elements, compressors, and thermoelectric devices. Compressor-based cooling systems, found in commercial refrigerators and air conditioners, contain three fundamental parts: an evaporator, a compressor, and a condenser. In the evaporator, pressurized refrigerant is allowed to expand, boil, and evaporate, absorbing heat as it changes from a liquid to a gas. The compressor acts as the refrigerant pump and recompresses the gas to a liquid. The condenser expels the heat absorbed (along with the heat produced during compression) into the ambient environment. Compressor-based systems can cool components far below ambient temperature with tight tolerances.

Temperature control is important in performing at least some forms of electrophoresis. Electrophoresis is a technique that is commonly used in research and clinical laboratory settings for the analytical and preparative separation of macromolecules, such as proteins and nucleic acids. Application of an electric field, typically a DC field of 50 to 200 volts or more, causes migration of charged molecules or molecular complexes through a separation medium. There are two main classes of electrophoretic techniques, capillary and gel electrophoresis. In gel electrophoresis, the separation medium is a hydrogel, usually agarose or polyacrylamide. The gel is typically immersed in electrophoresis buffer, for example Tris-Acetate-EDTA (TAE). In capillary electrophoresis, the separation medium may include a buffer and a linear polymer, such as linear polyacrylamide.

In the practice of gel electrophoresis, application of a greater electric field will effect a more rapid separation, thereby increasing the convenience and reducing the cost of the technique. Application of an electric field during electrophoresis to the electrophoresis buffer causes Joule heating, which increases the temperature of the electrophoretic gel and puts a limit on the level of voltage that can be applied. If too high a voltage is used, the excess heat will distort the electrophoretic separation and may degrade molecules in the sample and gel. It is known in the art to cool an electrophoresis buffer tank by performing the experiment in a refrigerated cold-room or through the use of a plastic cooling core through which a cold heat transfer fluid travels. This cooling allows use of a higher voltage and results in faster separations.

### SUMMARY OF THE INVENTION

In a first embodiment of the invention there is a temperature regulation system that includes a polished surface that is sufficiently smooth surface to reduce emissivity of the surface less than or equal to 6%. The system has a conduit, in fluid communication with a source of coolant fluid. The conduit is in thermal proximity to the polished surface. Cooled fluid is circulated through the conduit so as to transfer heat from the surface to the coolant fluid therein.

The coolant fluid may be a compressible refrigerant fluid and the apparatus may include a refrigeration assembly adapted to cool the refrigerant fluid and to circulate the fluid through the conduit so as to cool the surface to a given temperature.

The refrigeration assembly may include a miniature rotary compressor having a height of less than 15.5 cm, or 9.4 cm. the refrigeration assembly may be located remotely from the surface and may be connected to the conduit via a tubing assembly.

The refrigeration assembly may be integrally connected to the surface via a connection to a common base. In a specific embodiment, the surface may be disposed above the based on no more than 12 cm. In another specific embodiment the refrigeration assembly extends from the base by no more than 18 cm.

In a related embodiment emissivity of the surface is less than or equal to 4%. In another related embodiment, the surface may be a polished aluminum oxide layer that is disposed on a metallic aluminum substrate.

In a further embodiment the system may have a resistive heating element. The resistive heating element may be sprayed-on resistor.

In yet a further embodiment the system may include a block having at least one recess adapted to hold a laboratory vessel or device. The block has a flat bottom surface so as to establish efficient thermal contact with placed atop the polished surface. The recess may have been emissivity of greater than 50%. The block may be constructed from an aluminum substrate in the recesses may be black anodized. In a related embodiment, the block holds a laboratory device such as, a dialysis cell, a chromatography column, a dry-ice maker and a recirculation conduit.

An embodiment of the invention provides an apparatus for temperature control of an electrophoresis buffer in an electrophoresis tank. The tank is designed for electrophoresis having, for example, electrodes and fixtures for holding electrophoresis gels. At least one of the walls is a heat transfer wall that includes an electrically conductive material and is coated with a durable thermally conductive, but electrically nonconductive coating.

The heat transfer wall may be positioned in fluid communication with the electrophoresis buffer. The heat transfer wall may be a bottom wall. The heat transfer wall is typically coupled to a heat sink. Examples of suitable heat sinks include a recirculating chiller or a thermoelectric device. The heat transfer wall may include a passageway, such as a tortuous passageway, for the flow that the transfer fluid. The transfer fluid may be a liquid or gas, and if a liquid, may be pumped by a peristaltic pump.

The coating may be a spray coating and may cover the entire heat transfer wall. The spray-coating may include aluminum oxide or aluminum nitride. The coating may be applied by chemical or physical vapor deposition, by porcelainzing, or be powder coating with plastic. The interior of the heat transfer wall may advantageously be a metal, such as copper, steel, aluminum, titanium, nickel, or silver. The interior may also be a metal alloy. The interior may also be a semi-metal, or a cermet. The thickness of the coating may be greater than 1 micron.

A buffer stirring mechanism may be included in the apparatus and may be a magnetic mechanism for driving a stir-bar.

The apparatus may have a cooling core. The cooling core sits in, and removes heat from, the electrophoresis buffer tank. The cooling core may have a passageway, which may be tortuous, for the flow of heat transfer fluid such as may be pumped from a recirculating chiller. The recirculating chiller may include a peristaltic pump to urge the transfer fluid through the passageway.

An embodiment of the invention features an apparatus for the temperature control of an electrophoresis buffer that has a buffer holding tank, a cooling core with a passageway for the flow of heat transfer fluid, and a heat transfer block. The device may include a least one electrophoresis electrode and may include a positioning system for the positioning of a separation medium such as a slab gel. The heat transfer block may be a wall of the buffer holding tank and may be, on an interior side, in fluid communication with the electrophoresis buffer.

Another embodiment provides a method for manufacturing an electrophoresis buffer tank by coating an electrically conductive material with a thermally conductive but electrically nonconductive coating to form a heat transfer wall. The wall is incorporated into an electrophoresis assembly.

### BRIEF DESCRIPTION OF THE DRAWINGS

The foregoing features of the invention will be more readily understood by reference to the following detailed description, taken with reference to the accompanying drawings of embodiments, in which:

FIG. 1a is a schematic diagram of a benchtop heat transfer block with a remote compressor;

FIG. 1c schematically shows a cross sectional view of a heat transfer platen in accordance with FIGS. 1 and 2a;

FIG. 1b schematically shows a heat transfer block with tortuous heat transfer fluid conduit;

FIG. 2 is a schematic featuring an exploded view of a heat transfer apparatus;

FIG. 3 is a schematic diagram featuring an exploded view of a connecting tube assembly;

FIGS. 4a-4c show various embodiments of heat transfer blocks;

FIG. 4d schematically shows a cross sectional view of a heat transfer block in accordance with FIGS. 4a-4d;

FIGS. 5a to 5d show frames for holding heat transfer blocks in accordance with embodiments of the invention;

FIG. 6 shows a perspective view of a low-profile heat transfer platen with an integrated compressor;

FIG. 7a is a schematic top view diagram of the integrated device of FIG. 6;

FIG. 7b is a schematic side view diagram of the integrated device of FIG. 6;

FIG. 7c is a schematic top view diagram of the integrated device of FIG. 6 showing internal components;

FIG. 7d is a schematic side view diagram of the integrated device of FIG. 6 showing internal components;

FIG. 8 schematically shows a perspective view of an embodiment having an electrophoresis tank with a heat transfer block;

FIG. 9 schematically shows a plan view of a cooling-core in accordance with an embodiment of the invention;

FIG. 10 schematically shows a perspective view of an embodiment having an electrophoresis tank with a heat transfer block and a cooling core;

FIG. 11 schematically shows a perspective view of an embodiment having a stir-bar drive mechanism;

FIG. 12 schematically shows a cross-sectional view of a coated heating block;

FIG. 13 schematically shows a method for manufacturing an electrophoresis tank according to the embodiment of FIG. 8;

FIG. 14 shows a perspective view of an integrated thermal regulation and power supply;

FIG. 15 shows a perspective view of an integrated thermal regulation and power supply with an electrophoresis tank;

FIG. 16 shows a perspective view of an integrated thermal regulation and power supply with an electrophoresis tank, cover and electrodes;

FIG. 17 shows a perspective view of a simplified integrated thermal regulation and power supply with an electrophoresis tank, cover and electrodes.

It should be noted that, unless otherwise indicated in the figures or accompanying text, the foregoing figures and the elements depicted therein are not necessarily drawn to a consistent scale or to any scale.

### DETAILED DESCRIPTION OF SPECIFIC EMBODIMENTS

Definitions. As used in this description and the accompanying claims, the following terms shall have the meanings indicated, unless the context otherwise requires:

“Emissivity” shall mean a measure of the flux of thermal radiation of surface in air. Emissivity is expressed herein as a percentage of the theoretical maximum flux at room temperature.’

In accordance with an illustrative embodiment of the invention, a heat transfer surface is polished to create a low emissivity, that is, it radiates heat poorly. Accordingly, the surface may be cooled without undue use of energy and without causing an excess of condensation to collect on it. Adaptations may be included to ensure a uniform degree of cooling across the surface. The surface may be incorporated into a programmably temperature controlled system. By using such a system to control the temperature and placing an object on the surface, the object can be heated, cooled, or held at a given temperature. One or more resistive heaters may also be included and used to elevate the temperature of the surface, and may temporarily work against a cooler, and may elevate the temperature above ambient. Illustrative commercial uses for the surface include commercial food preparation, and pastry making. Illustrative laboratory uses include static or dynamic temperature control of dissection samples, analytical devices (including electrophoresis tanks and chromatography columns), storage containers, laboratory vessels (e.g., beakers, flasks, and reagent troughs), and arrays of vessels (e.g., test-tube racks, and microplates). A further embodiment features a low-profile, integrated heat transfer surface and heat pump.

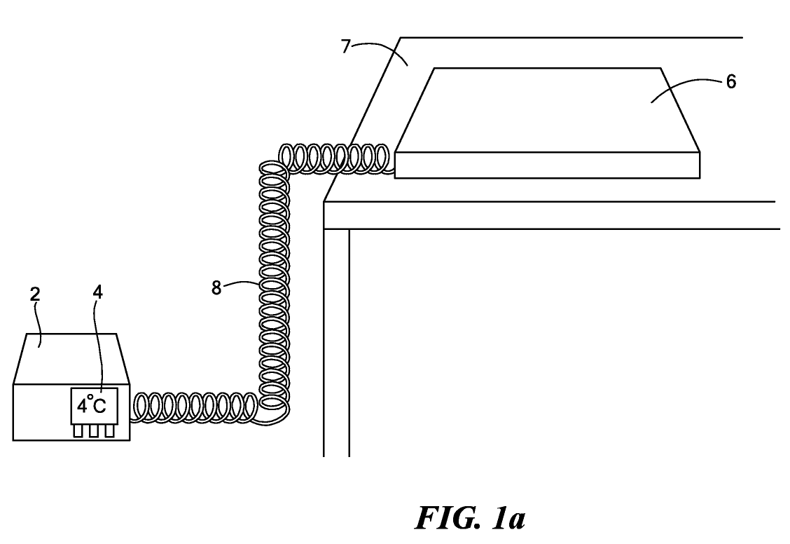

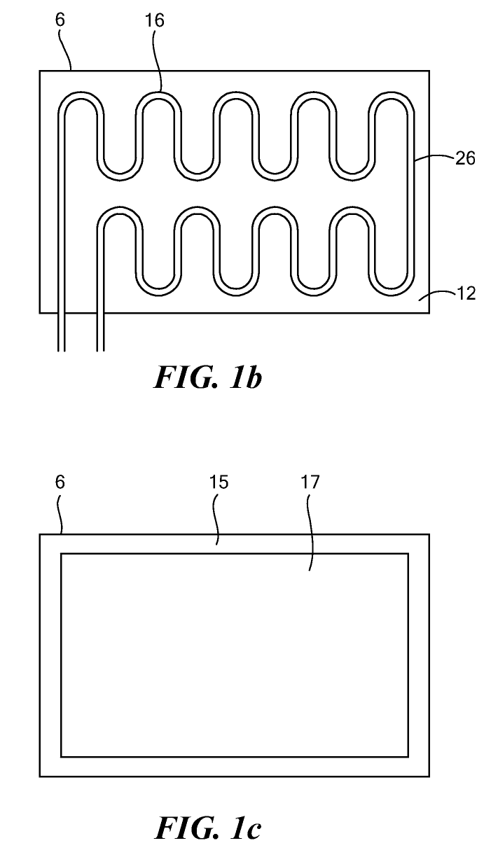

FIG. 1a diagrammatically shows a heat transfer platen 6 with a highly polished, low emissivity heat transfer surface. The platen 6 is resting on a bench 7 and connected to a refrigeration assembly 2 via a connecting tube assembly 8 that carries refrigerant to and from the plate 6. The refrigerant travels through a conduit (item 16 of FIG. 1b) that is in thermal contact with the platen 6, for example, a series of channels embedded in a platen 6 constructed of metal or other thermally conductive material. As shown in FIG. 1b, to ensure uniform cooling across the surface, the conduit 16 may be tortuous (e.g., serpentine) to allow for efficient and uniform heat transfer from the platen 6. In an alternate embodiment, refrigerant travels through a tube under the surface. The tube has pinholes; the refrigerant expands through the pinholes and into a collection chamber for return to a compressor.

The platen 6 may be constructed of metal. For example, aluminum is a relatively good conductor of heat and is relatively low cost compared to other metals such as copper. The platen 6 is highly polished, e.g. mirror polished in order to impart a low emissivity. As a result, the platen 6 will absorb heat from the air at a reduced rate. However, when a user places a solid object on the platen, heat will be efficiently transferred from the solid object to the platen 6. The solid object may be a laboratory device, examples of which are described below, having a flat, polished, or mirror-polished mating surface to better thermally mate with the platen 6. The smoothness of the polished surfaces, for this and for other embodiments described herein, may be characterized by the center line average roughness Ra (as described, for example, in U.S. Pat. No. 5,744,401). The surface finish may be in the range of Ra=2000 nm to 0.15 nm or less, and more preferably in the range of 10 nm to 2000 nm, however, one of ordinary skill in the art may determine, for a given material, the Ra value needed to reach a thermal emissivity in air at 4° C. of less than or equal to 10%, 6%, 4%, or in a preferred embodiment, 3%.

FIG. 1c shows an embodiment in which the platen 6 has a multilayer structure composed of an internal material 17 and a coating layer 15. The outer coating layer 15 may be composed of an electrically and/or chemically resistant material with a high thermal conductivity (due to its composition, thickness or both). Potential coating layer 15 compositions include metals, metal oxides, and cermets. For example, the coating layer 15, may be aluminum oxide or aluminum nitride. In an embodiment of the present invention, the coating 15 is a sprayed-on ceramic coating, such as may be produced by thermal-spray coating. The thermally sprayed ceramic coating may be formed from of one or more materials derived from a metal such as a metal oxide or metal nitride. The sprayed-on coating should be dense and/or thick enough to provide durability. Suitably dense thermally sprayed coatings of materials such as aluminum oxide and aluminum nitride may be achieved by the use of a high-speed thermal spray device. Examples of high-speed thermal spray devices include those that operate at supersonic velocities, e.g., Mach 2 to Mach 3 or higher. Suitable systems are commercialized by, for example, Praxair of Danbury, Conn. The coating layer 15 may be polished to create a low emissivity in air, in which case the coating should be thick enough to permit polishing. The platen 6 may include a drip catcher to collect condensation; for example, a gutter-like flange around the circumference of the platen 6 and/or a desiccant holder.

The coolant delivery assembly 2 delivers a flow of cooled heat transfer fluid or refrigerant (an expanding and contracting fluid that is part of a heat-pumping cycle). The coolant delivery assembly 2 may be a recirculating chiller that uses a compressor-based system to cool a heat transfer fluid and a separate liquid circuit to pump the cooled heat transfer liquid to the platen 6. Alternately, the conduit may be part of a heat-pump circuit and evaporated refrigerant may travel through the conduit. The refrigerant may be chosen to be stable to elevated temperatures sufficient to allow boiling of aqueous liquids in vessels on the surface. In alternative embodiments described below, the coolant delivery assembly 2 is integrated, as part of a common structure, with the platen 6. The coolant delivery assembly 2 may include a temperature control panel 4, which may allow the input of desired temperature and optionally, timing, control parameters and may have a display for the output of measured temperature, set temperature, set timing parameters, fault conditions, and the like. Alternately, the system may be controlled via a separate computer.

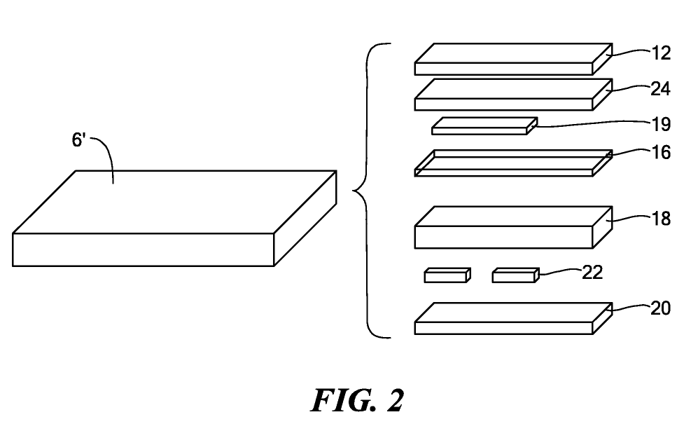

FIG. 2a schematically shows an exploded view of a platen 6, in accordance with a more specific embodiment of the invention. A base 20 supports multiple levels of structures below a temperature controlled plate 12 having a low-emissivity upper surface (e.g., polished to a 3% emissivity). A magnetic mixing mechanism 22 employs electromagnets to create an alternating magnetic field sufficient to rotate a stirbar or the like in a vessel positioned above the platen. A layer of insulation 18, such as a foam, may thermally isolate the electrical components to prevent damage to those component from condensation, and to conserve energy. The conduit 16 may be a may be a tortuous line to give uniform and rapid heat transfer, as in FIG. 1b, but may also be a linear tube or hollowed-out chamber. A temperature probe 19, e.g., a thermocouple, may be positioned sufficiently near the temperature controlled plate to give a reliable indication of the temperature of the plate in order to measure temperature of the plate. The temperature probe 19 may optionally be connected to a controller that uses the temperature measurements to maintain a desired plate temperature by adjusting heat transfer to or from the plate 12. The temperature of the plate 12 may be raised by application of current to a heater 24, which may employ one or more resistive heating elements. The heater 24 may heat uniformly across the area of the plate 12, or if multiple individually actuable heating elements are used, may be capable of selectively heating multiple areas of the plate 12 (e.g., via switching on and off, or adjustments in current flow). Accordingly, temperature zones and/or gradients may be formed. The heater 24 may be used in the absence of cooling, for example to boil water in a beaker sitting on the plate 12, or to sterilize the plate. The heater may also be used to apply heat while cooling at the same time; for example, the entire plate 12 or a region thereof may be alter the temperature of samples held in thermal contact with the plate 12 according to a time-temperature profile. Using multiple heating elements and appropriate control circuitry, temperature gradients may be created. The heater 24 may include one or more circuits created with a spraying process. For example, the resistive heaters may be created with a spraying-based process taught in U.S. Pat. No. 6,924,468 to Abbott, et. al, hereby incorporated herein by reference.

In another embodiment, a platen is composed or 5 layers (listed in order from bottom to top),

1) A lower chilled metal layer (e.g., an aluminum paten with a cooling conduit),

2) An insulating dielectric layer such as aluminum oxide, which may be sprayed on,

3) An heater, which may be a sprayed-on resistive heater,

4) A second insulating layer (e.g., sprayed on aluminum oxide)

5) An upper plate with an upper polished, low emissivity surface.

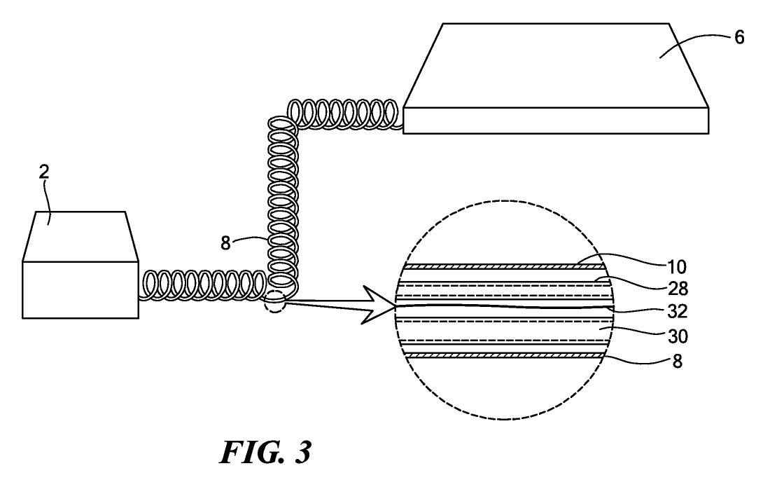

FIG. 3 schematically shows a close-up sectional view of a connecting tube assembly 8 in accordance with a further embodiment of the invention. The connecting tube assembly 8 may be composed of an outer casing 10, encasing a fluid supply tubing 28 and a fluid return tubing 30. The fluid supply tubing 28 and fluid return tubing may transmit a cooled heat transfer fluid, or a refrigerant from a refrigeration assembly to the platen 6. The tubing assembly 8 may be connected directly to the compression/expansion circuit of the refrigeration assembly and the fluid supply tubing 28 may be smaller in diameter than the return tubing 28. The connecting tube assembly outer casing 10 may optionally contain a temperature control feedback wire for transmitting signals from the temperature probe 19 to record temperature data and/or temperature-control circuitry.

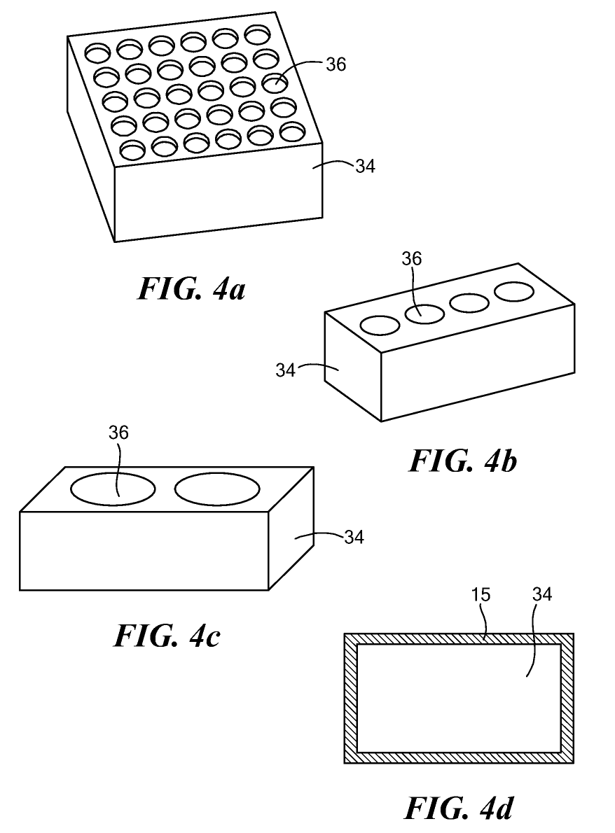

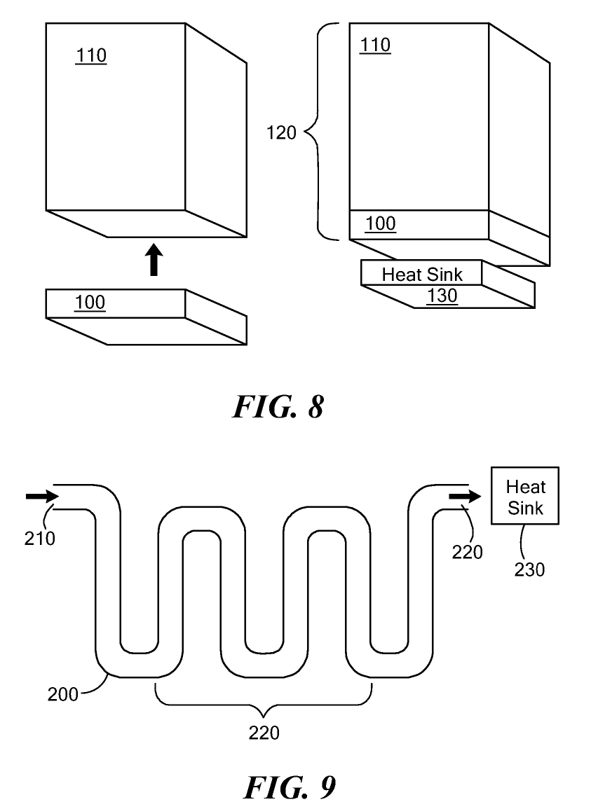

FIGS. 4a though 4c show several embodiments of receptacle blocks 34 which have cavities 36 suitable for holding laboratory vessels such as test-tubes, microfuge tubes, dialysis cartridges and the like. The cavities may also be large enough to hold a chromatography column, or electrophoresis buffer (described below with reference to FIGS. 8-17). The blocks 34 may be made to have a low thermal mass (e.g., by drilling out additional holes, not shown) so as to rapidly achieve a desired temperature. For example, sufficient material may be removed to reduce the mass of the block 34 by ⅓ or more. As shown schematically in FIG. 4d, the block 34 may have a coating layer 15, which may be similar to the coating layer of the plate 6 described above (FIG. 1c). The underside of the block 34 may be polished to allow for superior thermal contact with a polished upper surface of a platen 6. Optionally, the interiors of the cavities 36 may be constructed to have a high emissivity (e.g., at least 50%) so as to efficiently transfer heat to and from laboratory receptacles or device inserted therein. For example, the interior surfaces of the cavities 36 may be coated with black anodized aluminum, a material that may have a thermal emissivity in air of as high as 97%.

In related embodiments, blocks 34 may include a receptacle for an ice bath, a vortex chiller for making dry-ice, a dialysis chamber holder, a lyophilizer, and a magnet for separating magnetic particles from a liquid.

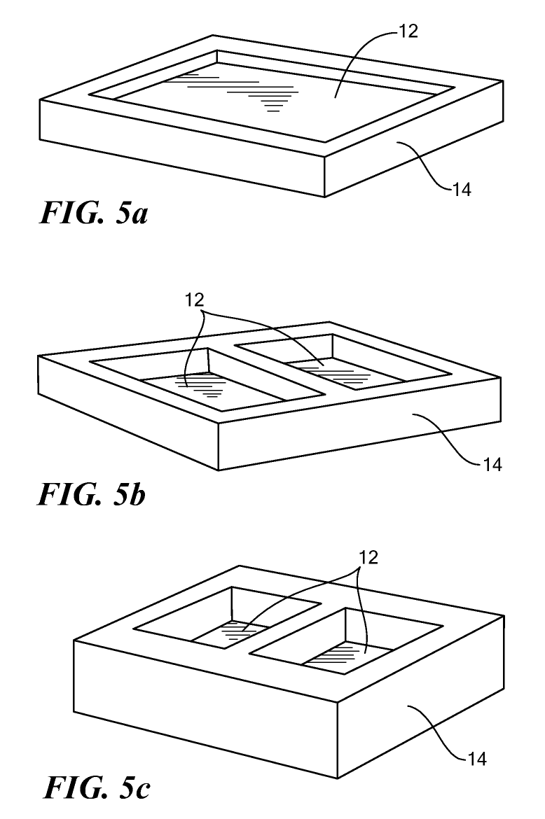

FIGS. 5a through 5c show several frames that may be positioned on the platen 6 to hold blocks 34 of various shapes and sizes. The frames may be constructed of an insulating material.

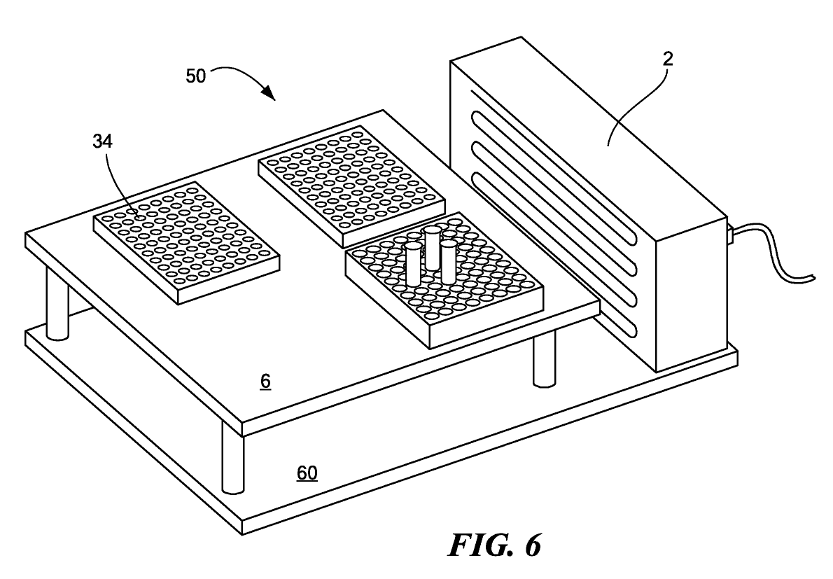

FIG. 6 shows an integrated device 50. A platen 6 and a compact refrigeration assembly 2 share a common base 60 so that they may be moved together. As a result, the device 50 is easily portable and has no cumbersome connecting tube assembly 8. The device is low-profile, e.g., the top of the refrigeration assembly extends only 15.5 cm or less from the uppermost surface of the base 60 and the top of the platen 6 extends only 10.5 cm or less from the uppermost surface of the base 60. The low profile of the refrigeration may be achieved by using a suitable powerful miniature compressor (e.g., a rotary vane or scroll compressor). One such compressor is commercialized as the miniCompressor Aspen Systems, Inc. a division of Cabot Corporation located in Marlborough, Mass. The Aspen Systems miniCompressor is approximately 7.4″ in height, has a diameter of approximately 5.3 cm, a weight of approximately 0.6 kg, and a housing volume of approximately 167 cm³. The platen 6 may optionally be mirror polished to achieve low-emissivity. Using a compressor allows energy-efficient cooling, even at temperatures well below ambient. Placing the compressor directly next to the platen 6 allows the use of a short, efficient coolant tubing system and a small overall footprint. In an alternate embodiment, however, a mini-compressor is used in the embodiment of FIG. 1.

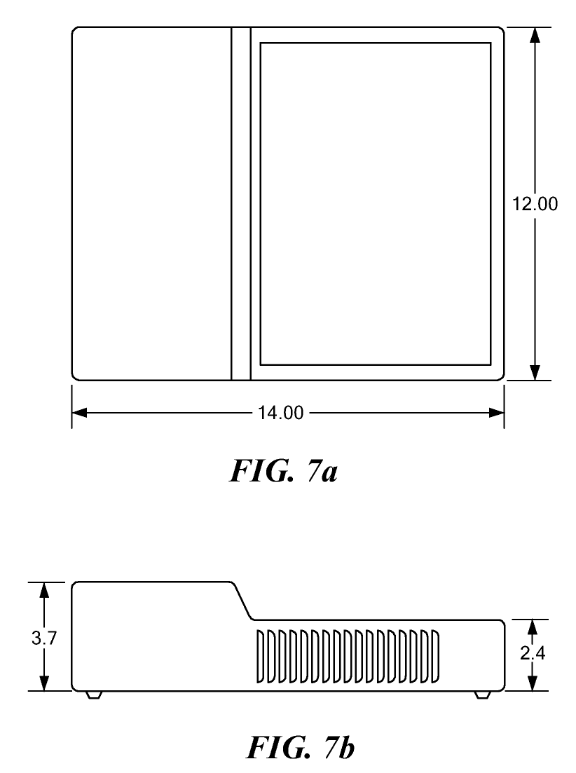

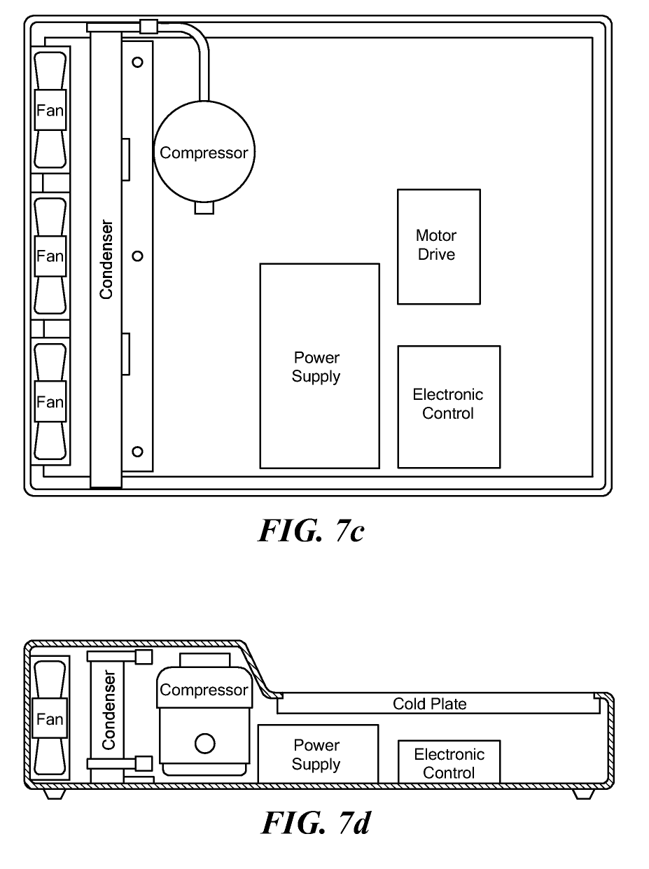

FIGS. 7a is a top view and 7b is a side-view schematic of an integrated device 50 in accordance with an embodiment of the invention. The dimensions are 14 inches (35.6 cm) long, by 12 inches (30.5 cm) wide. The platen height above the base 60 is 2.4 inches (6.1 cm) and the uppermost surface of the refrigeration assembly 2 is 3.7 inches (9.4 cm) above the base 60. FIG. 7c is top-view schematic showing the interior components of the device 50;

FIG. 7d is a side-view schematic. The device 50 includes a cold plate 6, compressor, condenser, fan(s), power supply, magnetic mixer drive, and control circuitry.

In related embodiments, the device 50 can accept input from a sensor (e.g., a pH or conductivity probe, spectrometer or fluorimeter) and change temperature settings based on that input to effect a chemical process. An imaging system may be used to monitor phase transitions such as melting, freezing or crystallization of a substance positioned in thermal contact with the platen 6. A valve or manifold may also be included to divert heat transfer fluid or refrigerant to another process; e.g., cooling a column, or oven.

FIG. 8 schematically shows a perspective view of an electrophoresis tank in accordance with an illustrative embodiment of the present invention. The electrophoresis tank is adapted to be cooled by a cooling plate such as the platen 6 described above. To increase the efficiency of cooling of an electrophoresis buffer tank 110, one or more of walls of the tank 110 include a heat transfer block 100. The buffer tank 110 is typically made of an insulating material, such as an injection-molded plastic, and is designed to receive electrodes and separation media such as slab gels. The tank 110 may be used for vertical or horizontal electrophoresis. The buffer tank 110, the transfer block 100, and a heat sink 130 together constitute a super-cooled electrophoresis unit 120, with improved cooling properties. The heat transfer block 100 may be held adjacent to a wall, embedded in a wall, or constitute a wall of the electrophoresis unit 120. If the block 100 constitutes a heat transfer wall it will be in direct fluid communication with (a consequently wetted by) electrophoresis buffer, which should be advantageous in terms of thermal coupling between the buffer and the heat sink 130. For such embodiments, it is important to electrically insulate the heat transfer block 100 while maintaining its ability to effect thermal coupling between the buffer and the heat sink.

The heat transfer block may be any wall of the tank 110. For example, as shown in FIG. 1, the heat transfer block 100 may form the bottom wall of the tank 110. In addition, the heat sink 130 may be passive, or may use active cooling component. Examples of active cooling components include thermoelectric devices (such as Peltier coolers), recirculating chillers with conventional refrigeration mechanisms based on the compression and expansion of gases, or combinations of the above mentioned or other suitable cooling devices.

FIG. 9 schematically shows a plan-view of a cooling-core 200 that may be used with embodiments of the invention. The cooling-core 200 is positioned in the tank of an electrophoresis unit 120 to remove heat during electrophoresis. During operation, a cooled heat transfer fluid (liquid, gas, or compressed gas) is pumped through the inlet 210, travels through a tortuous path 220, and exits through an outlet 230. A heat sink 220 such as a refrigerated, recirculating chiller removes heat from the fluid. Fluid is typically urged through the cooling-core with a pump, which may be a peristaltic pump.

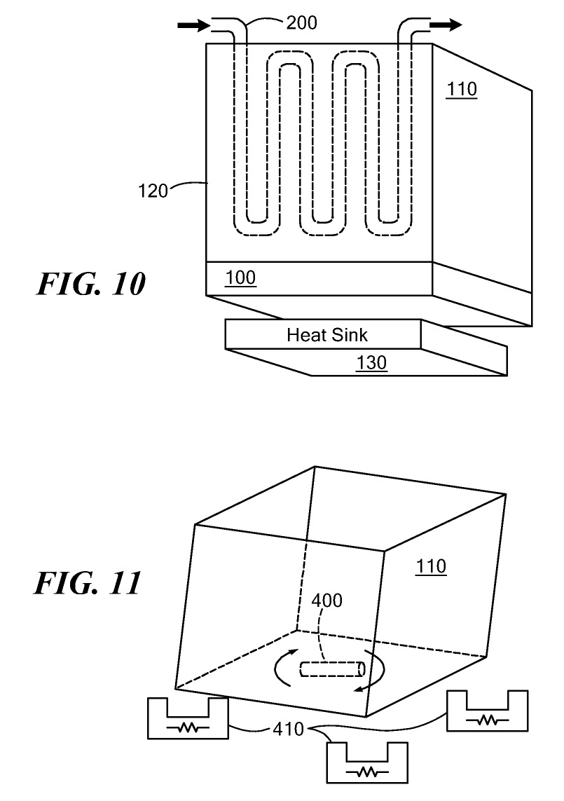

FIG. 10 schematically shows an embodiment having both a cooling core and a heat transfer block. An electrophoresis unit 120 has a cooling core immersed in its tank 110, and a heat transfer block 100. During electrophoresis, both the cooling-core 200 and the heat transfer block 100 remove heat from the tank 110.

To further increase the efficiency of cooling of the electrophoresis unit 120, a stirring mechanism is provided in accordance with an embodiment of the invention. Among other things, this stirring mechanism may be a propeller and shaft with a motor or, as shown in FIG. 11, a magnetic drive for driving a stir-bar. Electromagnets 410 actuate in an alternating manner, thereby creating a rotating magnetic field. When a magnetic stir-bar 410 is included in the electrophoresis buffer-tank 110, actuation of the electromagnets 410 will cause rotation of the stir-bar 400 and mixing of the electrophoresis buffer, thereby increasing the rate of thermal exchange between the buffer and one or more heat sinks.

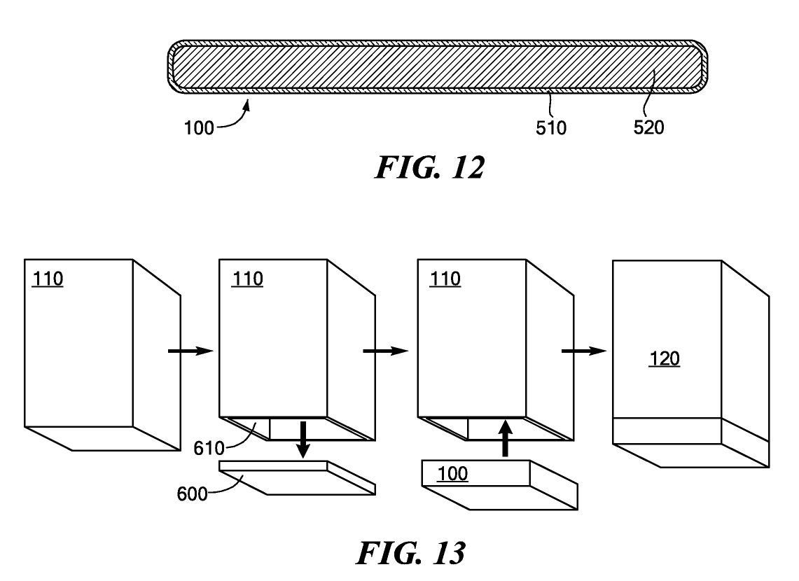

FIG. 12 schematically shows a cross-sectional view of an embodiment of the invention that features a heat transfer block 100 that has an interior 520 and an exterior durable coating 510. The block interior 520 may be formed of a thermally conductive material, such as metal, metal alloy, semi-metal, or cermet, which transfers heat away from the electrophoresis buffer tank 110. Examples of suitable metals include copper, aluminum, and steel. Cermets include any microscale or macroscale ceramic-metal composite. Examples of macroscale cermets include laminates of ceramic and metal and porous ceramics containing interstitial metals. As known in the art, metals are typically excellent conductors of heat, but are also typically excellent conductors of electricity. However, conduction of electricity across the heat transfer block 100 is not desired, especially when the heat transfer block 100 is used as a heat transfer wall of the electrophoresis unit 120. Conduction of electricity may lead to distortions of the electric field within the buffer tank 110, and could cause an electric shock to a user. Therefore, in embodiments using a metal or other electrically conductive material, the material may be coated with an electrical insulator. The electrical insulator chosen should not, however, prevent or significantly hinder the flow of heat from the electrophoresis tank 110 to the heat transfer block 100. The thickness of the coating should be chosen to prevent current from flowing across the coating. Specifically, the coating should prevent such current from disrupting the electric field inside the electrophoresis buffer tank 110 or causing electrical shock to a user. Even though the material used for the coating 510 may be inherently more thermally insulating than the block interior 520, use of an appropriately thin layer will render it thermally conductive. For reasons of reliability and safety, the coating should be made to be as hard as possible It is also important that the coating be durable and scratch resistant, i.e. it is not easily chipped, abraded or scratched off during normal use. For example, a coating that could be easily removed by a user's fingernail would have an insufficient durability.

In an embodiment of the present invention, the durable coating 510 is a sprayed-on ceramic coating, such as may be obtained by thermal-spray coating. The thermally sprayed ceramic coating may be formed from of one or more electrically resistive materials derived from a metal such as a metal oxide or metal nitride. For example, the coating materials may include aluminum oxide or aluminum nitride. The sprayed-on coating should be dense enough to provide electrical insulation and durability, as described above. Suitably dense thermally sprayed coatings of materials such as aluminum oxide and aluminum nitride may be achieved by the use of a high-speed thermal spray device. Examples of high-speed thermal spray devices include those that operate at supersonic velocities such as around Mach 2 to Mach 3 or higher. Suitable systems are commercialized by, for example, Praxair of Danbury, Conn.

A second way of forming the durable coating 510 is by using a porcelainzing process. A ceramic coating 510 may be applied by coating the block interior component 520 with a powdered ceramic and heating to fuse the powder into a durable coating 510. The fused ceramic coating 510 may include glass.

Combinations of plastics and ceramics may also be used to increase thermal transfer rates. The durable coating can also be made of a thermoplastic by a powder coating technique. Thermoplastic particles may be applied to the surface of the interior block 520 in a powder form and thermally or chemically fused to form a durable electrically insulating coating 510. Electrically insulating particles may be included in the coating to enhance thermal conductivity. The electrically insulating particles should have a higher thermal conductivity than the plastic used and could include ceramic materials such as aluminum oxide.

A durable coating 510 may also be produced by other techniques. For example, chemical vapor deposition (CVD), plasma enhanced chemical vapor deposition, physical vapor deposition (PVD), or plating techniques such as electroplating may be used. Note that any of the processes for making the durable coating 510 may also be used to create the coating layer 15 of FIGS. 1c and 4d.

The heat transfer block 100 also may have an interior passageway for the flow of a heat transfer fluid (liquid or gas). The fluid will remove heat in a manner similar to that described with reference to cooling core shown in FIGS. 9 and 10. For example, a serpentine groove may be machined in two copper blocks. The blocks may be coated with aluminum oxide via a spray technique and bolted together with a serpentine copper tube held between them. The tubing is then connected to a recirculating chiller for cooling and pumping a heat transfer fluid. Exposed portions of the pipe may also be coated with an electrical insulator for additional safety. The wall formed by the block 100 may be further electrically insulated on an exterior portion by, for example, a plastic covering. In this embodiment, the plastic covering should not hinder heat transfer since the heat flows primarily via the heat transfer fluid and not via the exterior wall. If the cooling core 200 is used, it and the block 100 may share the same recirculating chiller or other heat sink system. The methods used to create the heat transfer block 100 with an interior passageway may also be used to create the cooling core 200; for example, the cooling core 200 may have a metallic interior, and a thermally sprayed aluminum oxide exterior.

FIG. 13 illustrates an embodiment of the invention that features a method for manufacturing a super-cooled electrophoresis unit 120 in which an existing electrophoresis tank is retrofitted. For example, illustrative embodiments may retrofit a Bio-Rad (Hercules, Calif.) Protean II electrophoresis system. To that end, a section 600 or wall of an electrophoresis tank is removed to reveal a void 610. The section may be the bottom of the tank, but also could be a side wall. A component having a heat transfer plate 100 is then sealingly attached to cover the void to create a leak-resistant super-cooled electrophoresis unit 120.

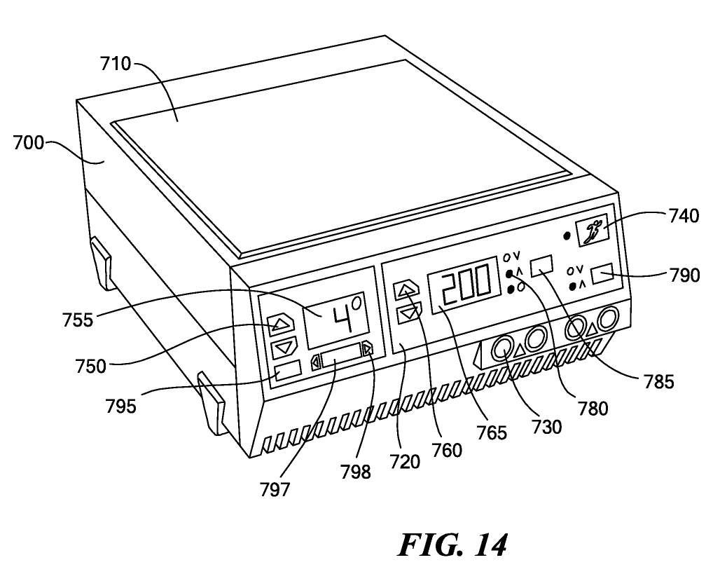

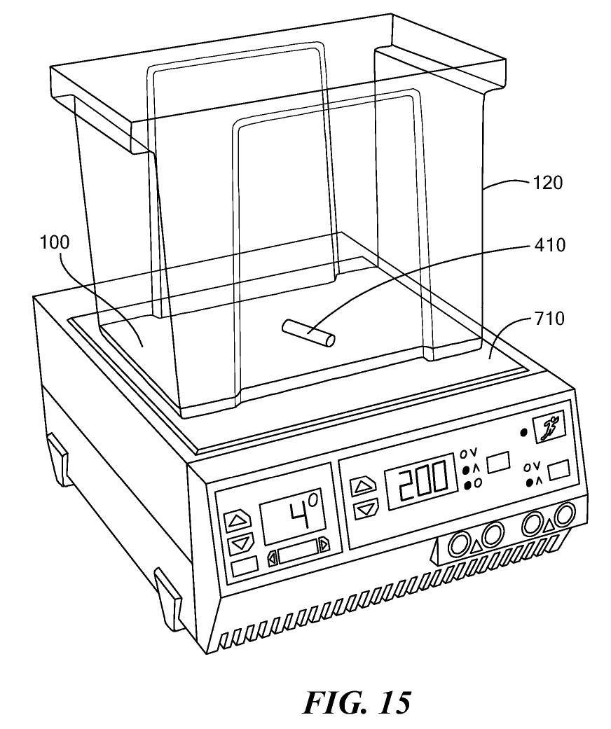

FIGS. 14-17 show exemplary embodiments in which a cooling device is combined with an electrophoresis power supply in a single enclosure, which may also feature controls and indicators. Such an integrated device 700 may have a built in electrophoresis power supply, a cooling plate 710, and an electromagnetic stir-bar drive (not shown). The interior electronics are advantageously water-resistant. The cooling plate 710, may have passages (which may be serpentine) for the flow of a coolant. The cooling plate 710 may be cooled by an onboard cooling source or by connection to an outboard cooling source. The cooling source may be for example, a recirculating chiller with a gas or liquid heat transfer fluid, a Peltier device, a tank of liquid nitrogen, a cold-water tap, or other appropriate source or combination of sources. If the cooling source is external, quick disconnects may be provided on the integrated device 700 for facile attachment of coolant lines. As shown in FIGS. 15-17, an electrophoresis tank 110 is placed on the cooling plate 710; heat is thus removed through the bottom of the tank 110. Multiple smaller tanks 110 or electrophoretic apparatuses of various configurations may also be used, although configurations with a bottom that allows a high degree of surface area contact with the plate 710 should cool more efficiently. Note that while depicted as a flat plate 710, variously shaped cooling surfaces will also work when used with a complementarily shaped electrophoresis tank. The device 700 will more efficiently remove heat from an electrophoresis buffer tank 110 when the tank 110 has is super-cooled electrophoresis unit 120 with a heat transfer bottom 100. In order to limit the formation of condensation due to ambient humidity on the exterior surface of the cooling plate 710, the cooling plate exterior may be constructed of a material with a low thermal emissivity. For example, a mirror polished metal surface may have a low thermal emissivity yet efficiently conduct heat when touched by the heat transfer bottom 100; for example, mirror-polished aluminum may be used to obtain an emissivity of about 3% or less.

The on-board electrophoresis power supply of the integrated device 700 may provide DC current. The electrical parameters are typically in the range of 50-3000 volts of potential, 0.1-2 amperes of current, and 75-400 watts of power. Electrical connection to one or more sets of electrophoresis electrodes may be provided by electrical output jacks 730, into which electrode leads are plugged-in during use.

Various controls and read-outs (e.g. LED or LCD displays) are included, typically on a faceplate 720 of the device 700. A switch 740 turns the device 700 on and off. A mode button 785 toggles between constant current, constant potential, and constant power modes. A constant current, potential (voltage), or power setting may be entered using buttons electrical control buttons and an electrical setting display 765. The actual current or potential is shown by an electrical reading display 785. Temperature control buttons 750 and a temperature display 755 are used to adjust and/or monitor the temperature settings. A stirring mechanism (e.g., actuation of a stir-bar 410) may be toggled on and off with a stir-bar power button 795, the speed of the stir-bar may be adjusted with stir-bar power buttons 798 and a stir-bar setting display 797.

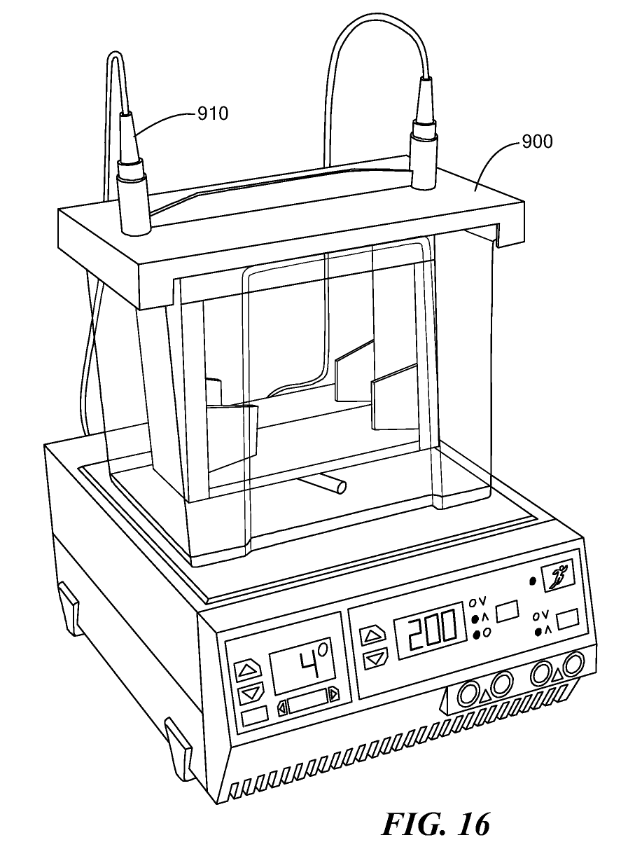

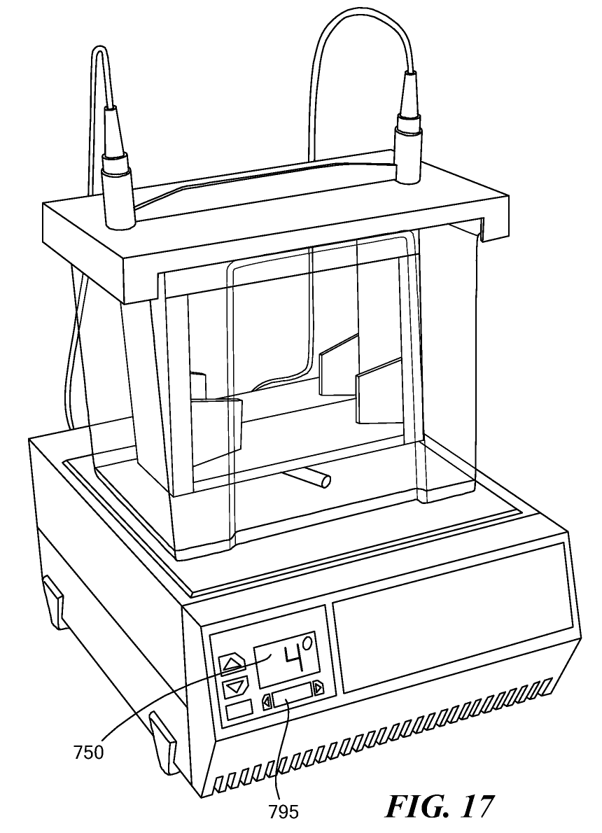

FIGS. 15 and 16 show a super-cooled electrophoresis unit 120 with a heat transfer bottom 100 atop a device 700 that integrates a cooling plate 710, stir-bar drive and electrophoresis power supply. A stir-bar 410 is within the electrophoresis tank. FIG. 15 shows the unit 120 without gels and a cover and FIG. 16 shows the unit 120 with electrophoresis gels, a cover 900, and electrodes lead wires 910. The heat-transfer bottom 100 of the unit 120 is constructed of machined aluminum that is black anodized and thermally sprayed on its upper surface with a highly dense coating of aluminum oxide to provide a high electrical impedance combined with a low thermal impedance. The bottom 100 may be machined to have a shallow depression to accommodate a stir-bar and then coated. The bottom 100 is then glued to a plastic wall-piece to create the super-cooled unit 120.

FIG. 17 shows an embodiment of a device 700, that is similar to the device 700 of FIGS. 7-9, but has only the cooling function and stir-bar driving functions; the electrophoresis power supply and associated controls, readouts and jacks have been omitted. The device 700 of FIG. 17 is intended to be used with a separate, external electrophoresis power supply.

Although the above discussion discloses various exemplary embodiments of the invention, it should be apparent that those skilled in the art can make various modifications that will achieve some of the advantages of the invention without departing from the true scope of the invention.

What is claimed is:

1. A temperature regulation system comprising:
a polished surface, the polished surface being sufficiently smooth so as to reduce the emissivity of the surface;
a conduit in thermal proximity to the polished surface, the conduit in fluid communication with a source of coolant,
wherein when the coolant is circulated through the conduit so as to transfer heat from the surface to the coolant fluid.

2. A system according to claim 1, wherein the coolant fluid is a compressible refrigerant fluid and the apparatus further comprises a refrigeration assembly adapted to cool the refrigerant fluid and circulate the fluid through the conduit so as to cool the surface to a given temperature.

3. A system according to claim 2, wherein the refrigeration assembly comprises a miniature rotary compressor, the compressor having a height of less than 15.5 cm.

4. A system according to claim 2, wherein the refrigeration assembly comprises a miniature rotary compressor, the compressor having a height of less than or equal to 9.4 cm.

5. A system according to claim 2, wherein the refrigeration assembly is located remotely from the surface and connected to the conduit via a tubing assembly.

6. A system according to claim 2, wherein the refrigeration assembly is integrally connected to the surface via connection to a common base.

7. A system according to claim 6, wherein the surface is disposed above the base by no more than 12 cm.

8. A system according to claim 7, wherein the refrigeration assembly extends from the base by no more than 18 cm.

9. A system according to claim 1, further comprising a resistive heating element.

10. A system according to claim 9, wherein the resistive heating element is a sprayed-on resistor.

11. A system according to claim 1, wherein the emissivity of the surface is less than or equal to 4%.

12. A system according to claim 1 wherein the surface comprises an aluminum oxide layer disposed on a metallic aluminum substrate.

13. A system according to claim 1, further comprising a block having at least one recess adapted to hold a laboratory vessel or device, the block having a flat bottom surface so as to establish efficient thermal contact when placed atop the polished surface.

14. A system according to claim 13, wherein the recess has an emissivity of greater than 50%.

15. A system according to claim 13, wherein the block holds a laboratory device selected from on of a dialysis cell, a chromatography column, a dry-ice maker, and a recirculation conduit.

16. A system according to claim 14, wherein the block comprises an aluminum substrate and the recess is black-anodized.

17. An apparatus for temperature control comprising:
a vessel having walls;
wherein at least one of the walls is a heat transfer wall that includes a electrically conductive material coated with a durable thermally conductive, electrically non-conductive coating.

18. An apparatus according to claim 17, wherein the heat transfer wall is positioned for fluid communication with an electrophoresis buffer.

19. An apparatus according to claim 17, wherein the coating substantially covers the entirety of the heat transfer wall.

20. An apparatus according to claim 17, wherein the heat transfer wall is a bottom wall.

21. An apparatus according to claim 17, wherein the thermally conductive, electrically nonconductive coating is a thermally sprayed coating.

22. An apparatus according to claim 21, wherein the thermally sprayed coating is applied with a thermal spray coater operating at a velocity of at least about Mach 2.

23. An apparatus according to claim 17, wherein the coating is applied via vapor deposition.

24. An apparatus according to claim 17, wherein the coating is a thermoplastic coating applied via powder coating.

25. An apparatus according to claim 24, wherein the thermoplastic coating contains particles that are thermally conductive and electrically non-conductive.

26. An apparatus according to claim 17, wherein the coating is a porcelain coating.

27. An apparatus according to claim 17, wherein the coating further comprises a material selected from the group consisting of aluminum oxide and aluminum nitride.

28. An apparatus according to claim 17, wherein the electrically conductive material is selected from the group consisting of a metal, a semi-metal and a cermet.

29. An apparatus according to claim 28, wherein the metal is selected from the group consisting of copper, steel, aluminum titanium, nickel and silver.

30. An apparatus according to claim 28, wherein the metal is an alloy.

31. An apparatus according to claim 17, wherein the thickness of the coating is greater than 1 micron.

32. An apparatus according to claim 17, further comprising a liquid stirring mechanism.

33. An apparatus according to claim 32, wherein the stirring mechanism drives a stir-bar.

34. An apparatus according to claim 17, further comprising a cooling-core for positioning within the tank.

35. An apparatus according to claim 34, wherein the cooling-core has a passageway for the flow of a heat-transfer fluid.

36. An apparatus according to claim 17, wherein the heat transfer wall includes a heat sink.

37. An apparatus according to claim 36, wherein the heat sink comprises a passageway for the flow of a heat transfer fluid.

38. An apparatus according to claim 37, wherein the passageway is tortuous.

39. An apparatus according to claim 37, further including a recirculating chiller.

40. An apparatus according to claim 37, wherein the recirculating chiller includes a peristaltic pump.

41. An apparatus according to claim 36, wherein the heat sink comprises a thermoelectric device.

42. An apparatus according to claim 37, wherein the passageway is adapted to receive a heat transfer fluid that is a gas.

43. A temperature controlled platen comprising:
a) a lower chilled metal layer;
b) an insulating dielectric layer;
c) a sprayed-on resistive heater;
d) a second insulating layer; and
e) an upper plate with an upper, polished surface.
